(19) United States
(12) Patent Application Publication
(10) Pub. No.: US 2023/0031228 A1
(43) Pub. Date: Feb. 2, 2023

(54) Support collar for cables, pipes or the like

(71) Applicant: Fi.Mo.Tec. S.p.A., Milano (IT)

(72) Inventor: Alberto Varale, Cologno Monzese (MI) (IT)

(21) Appl. No.: 17/389,725

(22) Filed: Jul. 30, 2021

(51) Int. Cl. F16L 3/13; H02G 3/04

(52) U.S. Cl. CPC F16L 3/13; H02G 3/0456

(57) ABSTRACT

A support collar for cables, tubes, or the like includes retaining arms, each of which includes a third segment extending from the free end of a second arched segment, in a direction opposite to a first V-shaped segment. Each third segment is shaped as an angled or arched winglet directed toward a corresponding side portion and/or at least one flap, so as to facilitate entry of the cable, tube or the like to slot between the arm segments.

### FIELD OF THE INVENTION

The present invention relates to a support collar for cables, tubes or the like.

### BACKGROUND OF THE INVENTION

As it is known, the supporting of cables or tubes in the telecommunications and building sector is achieved by using one or more support collars that can be fixed on perforated plates.

Support collars in fact comprise relatively elastic structures obtained by means of respective open profiles, which can be splayed to be rapidly fitted onto the cables or tubes to be supported.

In document EP 2464907, a support collar is described comprising a laminar structure having a flat head portion with a central opening, two side portions extending transversely from the head portion, each of which has a coupling element suitable for engaging the collar on a support plate or a flat head portion of another support collar, and a retaining clip for a long-shaped article positioned in the area determined by the head portion and the two side portions. The retaining clip is formed from the structure of a respective side portion of the collar.

This allows a saving of the material used for the production of the support collars; yet it limits the possibility of freeing the shape and dimensions of the arms of the clip from the dimensions of the side portions.

The elasticity of the retaining arms of the clip together with the presence of side portions without structural folds provides for an elastic yield which allows the support collar to easily adapt to different geometries and/or dimensions of the cables or tubes.

It is evident, however, also from the figures, that the collar described in document EP 2464907 cannot adapt, without the use of sleeves, to cables or tubes having an extremely reduced diameter.

The negative impact of the passive intermodulation or Pim (Passive Inter-Modulation) phenomenon on the infrastructure of mobile radio networks is also known. Basically, passive intermodulation takes place when various radiofrequency signals, coming from one to several radio base stations, mix together in a site that houses a cell, giving rise to a signal that contains a new set of frequencies.

Undesired signals due to passive intermodulation are generated due to some form of mechanical non-linearity. One of the major causes is the inconsistency of the contacts between metal and metal in the areas affected by high current intensities, such as those inside the transmission lines or within the radiofrequency (RF) components. This may be due to the imperfect preparation of the RF terminations or non-optimal assembly procedures, loosening of screws or rivets inside the RF components, contaminated or oxidized surfaces of the connectors, or RF connectors that are not properly tightened.

Passive intermodulation can therefore potentially considerably degrade the quality of the service of new networks, for example Lte (Long Term Evolution) and Hdspa+(High Speed Downlink Packet Access). It is of primary importance for telecommunications operators to reduce the negative effects of passive intermodulation in order to be able to install more advanced network infrastructures capable of supporting the transporting of broadband data, without a significant increase in costs and without jeopardizing the performance level.

Italian patent no. 102019000008184 discloses a collar made in a plastic material holding a cable or a tube in stable manner.

### SUMMARY OF THE INVENTION

The objective of the present invention is to provide a support collar for cables, tubes or the like capable of solving the above-described drawbacks and of improving the holding of the cable or tube and of facilitating a positioning thereof in the housing area of the support collar.

In particular, the objective of the present invention is to provide support collars with an elastically deformable structure and suitable for supporting cables having different geometries and sections, i.e., cables having thicknesses that vary from narrow cross-sections to wide sections, facilitating their insertion into the collar, regardless of their diameter.

Another objective of the present invention is to provide stackable support collars providing for an improved positioning over known collars along the longitudinal development of cables or tubes.

Another objective of the present invention is to reduce the production and marketing costs of support collars.

Another objective of the present invention to provide support collars that can eliminate the problem of the passive intermodulation phenomenon.

The above-described objectives are achieved by means of a support collar produced according to what is described hereinafter.

### BRIEF DESCRIPTION OF THE DRAWINGS

The structural and functional features of the present invention and its advantages with respect to the known art will appear even clearer and more evident from the following description, referring to the attached schematic drawings, which show non-limiting embodiments of the present invention. In the drawings:

FIG. 1 is a front view of a support collar for cables, tubes or the like, partly splayed, produced according to the present invention, for locking cables;

FIG. 2 is a front view of a support collar for cables, tubes or the like, partly splayed, produced according to the present invention, for locking cables with a larger diameter than the diameter of the cable lockable in the collar of FIG. 1;

FIG. 3 is a front view of a support collar for cables, tubes or the like, partly splayed, produced according to the present invention, for locking cables with a larger diameter than the diameter of the cable lockable in the collar of FIGS. 1 or 2;

FIG. 4 is a front view of a support collar for cables, tubes or the like, partly splayed, produced according to a first embodiment of the present invention, for locking cables with a larger diameter than the diameter of the cable lockable in the collar of FIG. 1, 2 or 3;

FIGS. 5 to 8a are perspective views of the collar of FIGS. 1, 2, 3 and 4 respectively;

FIG. 9 is a schematic front view of two support collars, according to the preceding figures, stacked on top of each other;

FIGS. 9a and 9b are perspective views of the stacked collars of FIG. 9;

FIG. 10 is a schematic front view of two support collars, according to the preceding figures, stacked on top of each other and engaged on a support plate.

### DETAILED DESCRIPTION OF EMBODIMENTS OF THE INVENTION

With reference to the figures, a support collar for cables, tubes or the like is indicated as a whole with 1.

The support collar 1 is made of a plastic material.

In particular it is made of a flexible, elastic and resistant plastic material.

According to the present invention, the support collar 1 for cables, tubes or the like comprises:

a head portion 2, having at least one pass-through opening 3;

two side portions 4 extending transversely and substantially perpendicularly from the head portion 2 and ending with two respective abutment portions 9 positioned parallel to the head portion 2;

each of the abutment portions 9 being provided with at least one respective coupling element 5 suitable for engaging the collar 1 on a support plate 15 or a head portion 2 of an additional support collar 1, the side portions 4, the abutment portions 9 and the head portion 2 of the support collar 1 delimiting an area 6 for the partial housing of the cable or tube C to be supported;

retaining means in correspondence with the housing area 6 to keep the cable or tube C firmly within the area 6.

The retaining means comprise at least one clip 7 provided with at least two retaining arms 7′ which extend inside the housing area 6.

The arms 7′ of the retaining clip 7 are flexibly connected to at least one of the portions 2, 4, 9 of the support collar 1 and can be elastically spread to engage the cable or tube C and hold it within the housing area 6 by applying a transverse elastic pressure upon the longitudinal development of the cable or tube C.

Support collar 1 includes also at least one flap 8 that is configured to cooperate with each of the at least two retaining arms 7′ and that extends into the housing area 6 from the surface facing the housing area 6 of each abutment portion 9, toward the head portion 2 and into the housing area 6. The at least one flap is positioned opposite the retaining arms 7′, so that the at least one flap 8 is abutted against the at least one retaining arm 7′ when the cable or tube C is engaged in the at least one clip 7.

The opening 3, shown as circular, can have any shape, such as, for example, rectangular, square, elliptical or the like.

Furthermore, the opening 3, according to an embodiment that is not shown, can be surrounded by a reinforcement collar.

The head portion 2, the two side portions 4 and the abutment portions 9 preferably have a substantially flat development.

Due to the coupling element 5, each abutment portion 9 of the support collar 1 can be arranged against a corresponding surface of the support plate 15 or the head portion 2 of another support collar 1.

The two side portions 4 extend perpendicularly, or obliquely, with respect to the head portion 2 to define a square, inverted U-shaped open profile.

Each of the two side portions has at least one window 4′ so that the side portion defines of a frame, giving the collar 1, in particular the two side portions 4, a certain lightness and elastic yield along directions transverse to the side portions side 4.

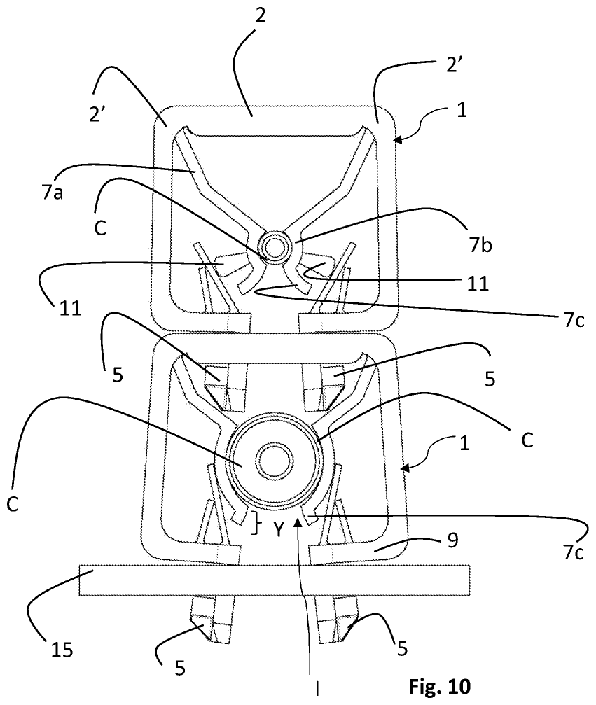

As is evident from the figures, the two side portions 4, the two abutment portions 9 and the head portion 2 of each collar 1 delimit an area 6 for the partial housing of an electric cable, a conduit, a tube, a bar or similar objects having an elongated shape C (FIG. 10).

The retaining means such as at least one clip 7, with at least two arms 7′, and flaps 8 are provided within the area 6, in order to keep the cable or tube C in a stable position.

As illustrated in the figures, the retaining arms 7′ are preferably flexibly connected to the corresponding edge 2′ of the head portion 2 with the side portions 4 and the at least one flap 8 extends from the surface of each abutment portion 9 facing the housing area 6 toward the head portion 2.

Each of the two arms 7′ of the retaining clip 7 cooperates with at least one flap 8 that extends obliquely from the surface of each abutment portion 9 facing the housing area 6 toward the corresponding side portion 4.

More specifically, the at least one flap 8 bends slightly toward a corresponding side portion 4, when it is abutted or in direct or indirect contact through at least one contact element 11, as described hereunder, with the corresponding retaining arm 7′ having the cable or tube C inserted between the two arms 7′.

The retaining arms 7′ can be elastically splayed to withhold the cable or tube C by transversely exerting on the latter, in combination with the flaps 8, a pressure sufficient for keeping it in a stable position, whatever the diameter of the cable or tube C may be.

The arms 7′, cooperating with the respective flap or flaps 8, transversely constrain the cable or tube C to the support collar 1, thus facilitating the assembly of cables or tubes C by operators.

According to an embodiment that is not illustrated, the cable or tube C may be held by arms 7′ that extend from respective edges 2″ positioned on the opposite side of the head portion 2, in correspondence with the coupling elements 5, the arms 7′ cooperating with flaps 8, which are provided on the head portion 2, laterally with respect to the pass-through opening 3, and which extend inside the housing area 6.

The arms 7′ may also, obviously, extend inside the housing area 6 starting directly from the side portions 4 or from the head portion 2 that are adjacent to the opening 3.

With reference to the retaining means 7 and in particular to the arms 7′, each retaining arm 7′ comprises a first substantially V-shaped segment 7a that extends from a respective edge 2′ of the collar 1 toward the center of the housing area 6.

The advantage of the V-shape of segment 7a is that it provides for space to insert, through opening 3, the locking element 5 of another support collar 1, which can be stacked onto the support collar located underneath it.

A second curved segment 7b develops from the first segment 7a and has a concavity directed toward the center of the housing area 6 which provides for a suitable resting surface for the outer surface of the cable or tube C to be supported.

As clearly shown in the figures, particularly FIG. 10, the shape of arms 7′, that is, segment 7b departing from the free end of V-shaped segment 7a, with no other segments extending into the housing area 6 toward the hole 3, facilitates, for collars 1 adapted for high diameter cables, the insertion of the locking elements of a second collar into hole 3, considering that any interference is prevented between arms 7′ of a support collar 1 and the locking element 5 of another support collar 1 stacked on top of the first collar 1.

In the known collar embodiments as described in IT102019000008184, elements 7c of arms 7′, which develop in opposite directions compared to elements 7b, may interfere with elements 5 of a second collar stacked on top that are inserted into the hole 3 of the first collar, with the risk of an accidental disengagement of the collars, an unstable hold, or even the inability of locking in the case of collars for large cables.

The present invention provides a solution to these drawbacks in the prior art.

According to the present invention, each retaining arm 7′ includes a third 7c segment that extends from the free end of a second arched segment 7b, in a direction opposite to the first, substantially V-shaped segment 7a, each third segment 7c being shaped as an angled or arched winglet toward a corresponding side portion 4 and/or toward the at least one flap 8, so as to facilitate the entry of the cable, tube or the like C between the segments 7b of the arms 7′ of clip 7.

The third segment 7c may be arched, in the shape of a boat, or angled toward the corresponding side portion 4 of collar 1.

From the second segment 7b, in the direction of each abutment portion 9, a third segment 7c extends, which may be:

in the shape of a curved, or folded, element or fin, whose free extremities face the side portions 4 and/or the at least one flap 8, or

in the shape of a flat and angled element or fin, with free extremities that face the side portions 4 and/or the at least one flap 8,

so as to facilitate the housing and engagement of the cable or tube C between segments 7b of arms 7′ of the clip 7.

As shown in the figures, each segment 7c, has its free end facing the respective abutment portion in the direction of the edge 2″ that it forms with the corresponding side portion 4.

This pair of third segments 7c, placed near the entrance of the housing 6 of the cable C, facilitates the positioning of the cable or elongated element C and creates an easier path or an entry point into opening I.

The third segments 7c have sizes that allow them to not interfere with flaps 8 even when the cable or tube C is inserted between the two segments 7b of the arms 7′ of the clip 7 of the collar 1.

The transversal extension, that is, the extension toward the side portions 4 and/or toward the at least one flap 8, or the width Y of each third arched or angled segment 7c is inversely proportional to the size of the second arched segments 7b.

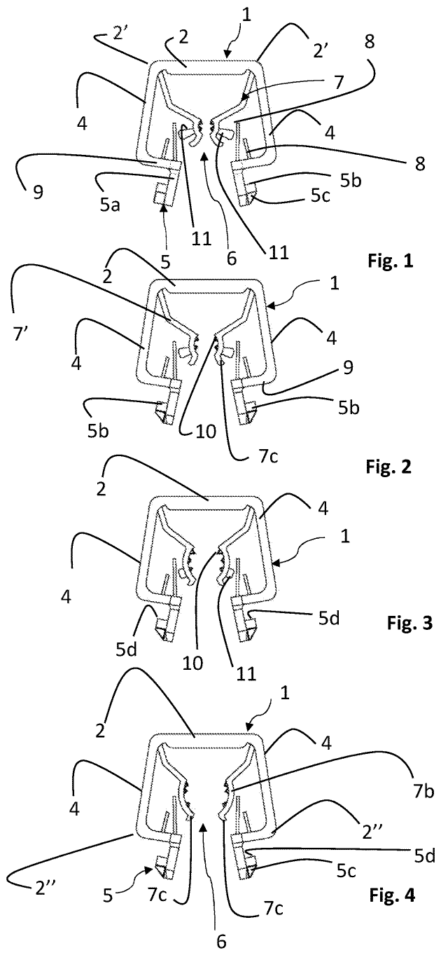

As it can be seen, in particular, in FIGS. 1 to 4, which depict the different dimensions of segments 7b for cables C, depending on cable diameter, the width Y of the third segments 7c is variable, preferably larger in collars 1 adapted to house cables of reduced diameters (for example, fiber optic cables). This way, a wider entry point is created (as the segments 7c are angled or arched toward the outside, that is, toward the side portions 4) for cables of reduced diameters.

As clearly shown in FIG. 1, the absence of the segments 7c would make it extremely difficult to insert cable C between segments 7b located in the housing area 6, which define an extremely small entry opening in clip 7 compared to the overall size of collar 1.

On the contrary, as can be seen in FIG. 4, in collars 1 adapted to house cables having a large diameter, the width Y of the segments 7c is reduced, so that, when the cable C is inserted in the clip, any interference between the segments 7c and the flaps 8 is avoided.

To improve the grip of the two arms 7′, the arched surface of the second segment 7b facing the center of the housing area 6 and intended to come into contact with the outer surface of the cable or tube C to be supported, may have one or more teeth, dowels, or retaining blades 10 in order to improve the grip that the retaining arms have on the cable or tube.

As it can be seen from the figures, the segments 7b may have different sizes and curvatures to adapt to the dimensions of the cable or tube C to be supported,

In particular, may vary depending on the diameter of the cable or tube. Segments 7c can also be of different sizes, in particular, their width Y increases as the size of segments 7b decreases, so as to facilitate the insertion of the cable by creating an opening that is easier to access, that is, by increasing the size of the entry opening between segments 7b of the clip 7.

As shown in the figures, the second segment 7b of the arm 7′ of each side portion 4, in particular its surface opposite to the surface facing the housing area 6 and, therefore, its surface opposed to the surface in contact with cable or tube C, cooperates with at least one flap 8 disposed on each abutment portion 9 and facing the housing area 6. The flap 8 ensures that the cable or tube C is stable and safely positioned between the arms 7′ of the retaining means 7 when the support collar 1 is engaged to the support plate 15 or an additional support collar 1. When the cable or tube C is placed between the arms 7′ of the retaining means 7, the arms 7′, being elastically movable, receive the cable at the second segment, 7b, and move to rest on the surface of the flaps 8, which, by being also elastically movable, provide an elastic resistance to an additional and excessive spreading of the arms 7′, providing a stable hold of the cable in the housing area 6 of the support collar 1. In particular, the outer surface of the arms 7′ facing the side portions 4, at second segment 7b, enters into contact, directly or indirectly, with the surface of the flaps 8. Each of the two abutment portions 9 may have at least one fin 8.

Preferably, two flaps 8 may be provided, disposed parallel to each other, for each of the abutment portions 9, whereas the second flap 8 of each section 9 increases the elastic resistance offered to the spreading of the arms 7′ whenever the cable or tube C is placed between the retaining means 7.

As shown in the figures, in order to insure the contact between arms 7′, in particular between second segments 7b and the flaps 8, there may be provided, on the outer surface of each second segment 7b of the arms 7′, that is, on the surface of the second segments 7b facing each side portion 4, at least one contact element 11, in the shape of a tooth or similar, ensuring direct or indirect contact between flaps 8 and arms 7′ even when the cable or tube C has a reduced diameter and, therefore, the retaining means 7 of the cable or tube C, being also of reduced dimensions, are located centrally in the housing area 6, occupying a small area within area 6 and, therefore, being further spaced from the flaps 8.

As shown in the figures, for example FIGS. 1-3, the contact element 11 is located on segment 7b of each arm 7, above the connection point between segment 7b and segment 7c.

As shown in the pictures, the contact element 11 is located on segment 7b, between segment 7a and segment 7c.

The contact element 11 is located on the second segment, 7b, above the third segment 7c.

Preferably, in order to facilitate the contact between the contact element 11, shaped as a tooth or similar, of each arm 7, and the respective flaps 8, the contact element is located on segment 7b, between segment 7a and segment 7c, near segment 7c.

This position of contact elements 11 provides for a higher point of contact with flaps 8, that is, in the free section of the flap, that opposite to the extremity fixed to the abutment portion 9, that is, the section with the highest flexibility and/or elasticity. Therefore, flaps 8 can bend more easily after inserting the cable or tube C, especially when a pair of flaps 8 for each abutment portion 9 is provided, in the area in which they do not interfere with the outermost flaps 8.

Moreover, because the contact elements 11 are not present on the free extremity of segment 7b but only on its outer surface, a couple of segments 7c may be provided at the free extremity of segments 7b creating a channel that facilitates the insertion of cable C, as they are curved toward the inside, or straight but angled toward the inside, that is, toward the side portions 4 of the support collar 1 in order to create an upside-down V-shaped entrance into the housing for cable C, with the aim of “guiding” the cable during insertion into the seat in the clip 7.

These features make it easier to install cables, tubes, or similar elements, especially when inserting the cable into its seat within the clip 7.

As described above, the arched segments 7b that receive cable C, being linked to the free ends of segments 7a that are substantially V-shaped, make the engagement of additional collars safer, avoiding the interference between arms 7 of a first collar and the locking element 5 of a second collar 1 located above the first collar 1.

As shown in the figures, the retaining function of cable or tube C performed by the retaining means 7 is independent and unrelated to the locking function of the support collar 1 to the support plate 15 or to another support collar 1.

Retaining arms 7′ ensure that the collar 1 is engaged with the cable or tube C independently from the locking of the support collar 1 to another collar 1 or plate 15.

This provides the advantage of making it easier for operators to assemble cables.

The locking element 5 of each side portion 4 of the support collar 1 extends, outside of the housing area 6, from the surface of a respective abutment portion 9, which in turn 9 extends substantially parallel to the head portion 2 with a substantially flat development to ensure a stable support for the support collar 1 on plate 15 or on the head portion 2 of another support collar 1.

Due to the locking element 5, the collar 1 is fixed to another collar 1 or on a plate 15.

Referring to FIGS. 1-4, each locking element 5 comprises a small plate 5a extending transversely, perpendicular to the surface of the anchoring portion 9, on the opposite side relative to the head portion 2. On the surface of the plate 5a, a wedge-shaped element 5b is provided, with a rounded profile and an inclined surface 5c in relation to plate 5a to facilitate the introduction of the locking element 5 in the opening 3 of a second support collar 1 or in the hole of a plate 15.

The wedge 5b has an abutment surface 5d, which is substantially parallel to the surface of the abutment portion 9 that becomes positioned on the surface of a second collar 1, as illustrated in FIG. 9, or against the surface of a plate 15, as illustrated FIG. 10.

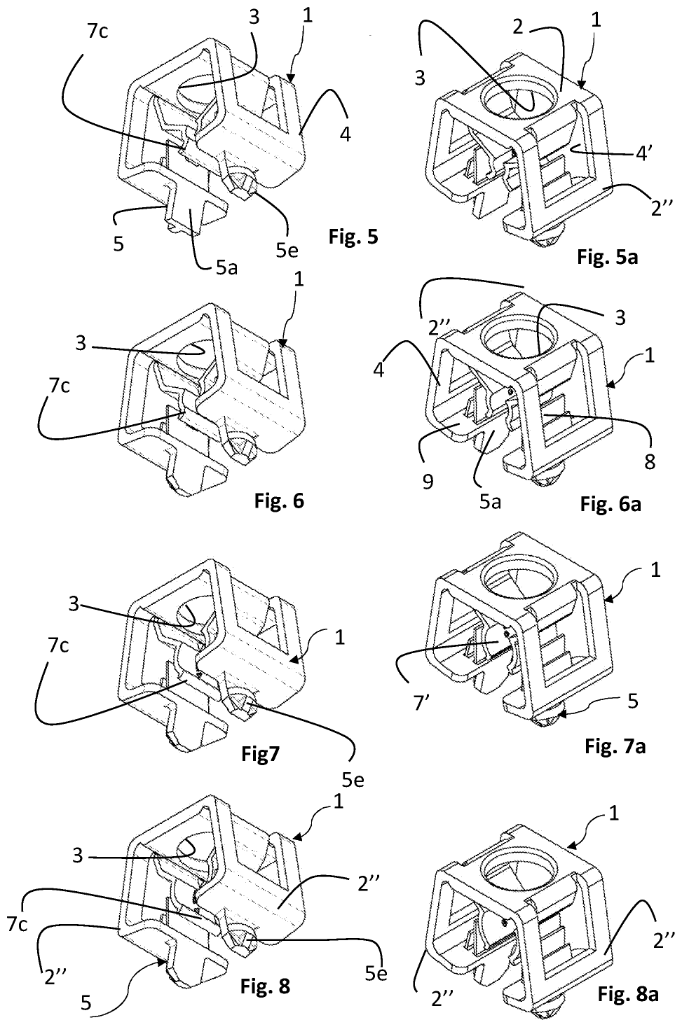

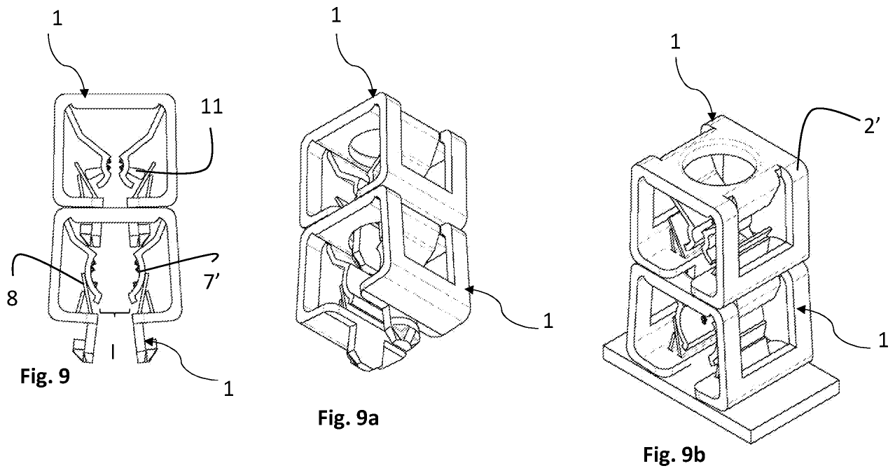

In a different embodiment illustrated in FIGS. 5-8a, a T-shaped element 5e is provided on the surface of the small plate 5a, with a head portion having a rounded profile and an elongated portion having an inclined surface serving the same purpose as the above-described wedge element 5b, which provides the advantages of further lightening the structure of collar 1 and generating a reduction in the amount of the plastic material required for manufacture.

Obviously, other shapes for the locking element 5 may be devised, for example a locking element 5 having two wedge-shaped elements arranged on the sides of the corresponding small plate 5a.

The present invention introduces a support collar for cables that is cheap, light, easy to manufacture, that solves the issue of passive intermodulation, and that facilitates a stable and safe insertion and the engagement of cables.

Moreover, due to the elasticity of the plastic material used for manufacturing and to having the arms 7′ of the retaining means cooperate with the flaps 8, a stable support of the cable C is generated so as to facilitate the positioning of the support collar 1 on the target structure.

The above-described structure of the support collar 1 further provides the manufacturing advantage of producing a part of the collar 1 that is identical for all cables C to be engaged, regardless of their diameter, that is, the part surrounding the housing area 6: the head portion 2, the side portions 4, the abutment portions 9, the locking elements 5, and the flaps 8. Advantageously, in fact, the only part that is molded with different shapes depending on the diameter of the cable to be supported are the retaining means 7, that is, the retaining arms 7′ and any contact elements 11 provided on such arms to ensure contact between arms 7′ and flaps 8 even when the arms 7′ are of reduced dimension and are positioned in the housing area 6 too spaced from the flaps 8 that a stop contact is prevented even when cable C is inserted.

Contact elements 11 provide a solution to this problem.

This structure of the collar 1 also allows, during the molding of the collar, producing the flaps 8 arranged within the housing area with the same degree of inclination, with no need to change orientation depending on the diameter of cable C.

Unlike the support collars disclosed in the prior art, which are made from a metal sheet and not usable for all cables, particularly not for small diameter cables without using a sleeve or similar device to increase the diameter of the cable, because the retaining arms, generated from metal sheets, are not long enough to wrap the cable; a support collar according to the present invention is extremely versatile due to the combination of flaps 8 and arms 7′ as described and claimed, and due to the potential addition of contact elements 11 and/or teeth, dowels, or retaining blades 10.

“Substantially” indicates a possible deviation of ±20%.

The scope of protection of this invention is, therefore, defined by the enclosed claims.

The invention claimed is:

1. A support collar for cables or tubes, comprising:
a head portion having at least one through opening;
two side portions extending transversely and substantially perpendicularly from the head portion and ending in two respective abutment portions disposed parallel to the head portion;
wherein the abutment portions each comprise a locking element configured to engage the collar on a support plate or on a head portion of an additional support collar, the side portions, the abutment portions, and the head portion of the support collar delimiting a housing area configured to partially house a cable or a tube to be supported therein;
retaining means disposed within the housing area to maintain the cable or tube stable inside the housing area,
wherein the retaining means comprise a clip provided with at least two retaining arms extending into the housing area, the at least two retaining arms being flexibly connected to at least one of the side portions, the abutment portions, and the head portion, and being elastically spreadable to engage the cable or the tube and hold the cable or the tube within the housing area by applying an elastic pressure transversally to a longitudinal development of the cable or the tube, each of the retaining arms of the clip comprising a substantially V-shaped first segment extending from a corresponding edge of the head portion with the side portions toward a center of the housing area, a second arched segment extending from a free end of the first segment and that has a concavity facing the center of the housing area and that provides a seat configured to receive an outer surface of the cable or the tube to be supported; and
at least one flap, configured to cooperate with each of the at least two retaining arms,
wherein the at least one flap extends from a surface of each abutment portion facing the housing area toward the head portion, and extends into the housing area, the at least one flap being positioned opposite the at least two retaining arms, so that the at least one flap abuts one of the at least two retaining arms when the cable or the tube is engaged in the clip, and
wherein each retaining arm further comprises a third segment extending from a free end of the second arched segment, in an opposite direction, to the first, substantially V-shaped segment, each third segment being configured as a winglet which is inclined or arched winglet toward a corresponding side portion and/or toward the at least one flap, so as to facilitate entry of the cable or the tube between the retaining arms of the clip.

2. The support collar as per claim 1, wherein a width of each third segment is inversely proportional to a size of the second arched segments.

3. The support collar as per claim 1, further comprising at least one contact element provided on a surface of each of the second segments of the retaining arms facing a respective side portion, the at least one contact elements being tooth-shaped, so as to ensure an indirect contact between the flaps and the at least two retaining arms even when a diameter of the cable or the tube to be retained is smaller than a size of the housing area, the at least one contact element being positioned on the second segment above the third segment.

4. The support collar as per claim 3, wherein the at least one contact element is positioned on the second segment, between the first segment and the third segment, adjacently to the third segment.

5. The support collar as per claim 1, wherein each of the at least two retaining arms is flexibly connected to a corresponding edge of the head portion with the two side portions, and wherein the at least one flap extends from a surface of each abutment portion facing the housing area toward the head portion.

6. The support collar as per claim 1, wherein the at least one flap extends obliquely toward a corresponding side portion of a surface of each abutment portion and toward the head portion, bending slightly toward the corresponding side portion when abutting with a corresponding retaining arm when the cable or the tube is engaged in the clip.

7. The support collar as per claim 1, wherein the support collar is manufactured from a plastic material.

8. The support collar as per claim 1, further comprising, on a surface of the second arched segment configured to come into contact with the outer surface of the cable or tube to be supported, one or more teeth, dowels, or retaining blades so as to increase a grip of the at least two retaining arms on the cable or the tube.

9. The support collar as per claim 1, wherein the at least one flap comprises at least two flaps for each retaining arm, disposed parallel to one another.

10. The support collar as per claim 1, wherein the head portion, the two side portions and the abutment portion are substantially flat.

11. The support collar as per claim 1, wherein one or both side portions include a central window so that the respective side portion defines a frame.

12. The support collar as per claim 1, wherein the clip for the cable or the tube is disposed to hold the cable or the tube independently and separately from engaging the support collar to a support plate or an additional support collar.

13. The support collar as per claim 1, wherein the locking element includes a second plate extending transversely and perpendicularly to a surface of the abutment portions, the second plate being directed opposite to the head portion, further comprising, on an outer portion of the second plate, a wedge-shaped element with a rounded profile, an inclined surface of the wedge-shaped element favoring an insertion of the locking element into the opening of a second support collar or into a hole of the support plate.

14. The support collar as per claim 1, is wherein the locking element includes a second plate extending transversely and perpendicularly to a surface of the abutment portions, the second plate being directed opposite to the head portion, further comprising, on an outer portion of the second plate, a T-shaped element having a distal portion with a rounded profile and an elongated portion with an inclined surface that favors an insertion of the locking element into the opening of a second support collar or into a hole of the support plate.
